(19) United States
(12) Patent Application Publication
(10) Pub. No.: US 2008/0012365 A1
(43) Pub. Date: Jan. 17, 2008

(54) Elastic vehicle bumper

(76) Inventor: Steven M. Harvey, Austin, TX (US)

Correspondence Address: MICHAEL O. SCHEINBERG, P.O. BOX 164140, AUSTIN, TX, 78716-4140, US

(21) Appl. No.: 11/825,135

(22) Filed: Jul. 2, 2007

Related U.S. Application Data
(60) Provisional application No. 60/817,930, filed on Jun. 30, 2006.
(60) Provisional application No. 60/855,870, filed on Nov. 1, 2006.

(51) Int. Cl. B60R 19/18

(52) U.S. Cl. 293/120

(57) ABSTRACT

A bumper system that is relatively inexpensive, easy to install and replace, and that significantly eliminates or reduces bumper or vehicle damage from low impact collisions. In a preferred embodiment, the use of multiple bumper pads, each having multiple crush cells and formed from a suitably elastic material, serves to significantly reduce or eliminate damage to the vehicle resulting from a low-impact collision. The present invention is particularly suited for bumper systems used on work trucks, delivery vehicles, utility vehicles, or fleet vehicles.

This application claims priority from U.S. Provisional App. No. 60/817,930 filed Jun. 30, 2006, and from U.S. Provisional App. No. 60/855,870 filed Nov. 1, 2006, both of which are hereby incorporated by reference.

### TECHNICAL FIELD OF THE INVENTION

The invention relates to vehicle bumpers, more particularly to a vehicle bumper formed from an elastic medium suitable for absorbing energy during low-speed impacts.

### BACKGROUND AND SUMMARY OF THE INVENTION

A bumper is a mechanical device typically made of steel, aluminum, rubber, or plastic that is mounted on the front or rear of a motor vehicle to absorb the shock from relatively low-impact collisions in order to prevent or reduce damage to the vehicle. Motor vehicle bumpers are not typically designed to be structural components that would significantly contribute to vehicle crashworthiness or occupant protection during front or rear collisions. In other words, bumpers are not safety features intended to prevent or mitigate injury to occupants inside the vehicle. Instead, bumpers are designed to protect the body of the vehicle (for example, the hood, trunk, grille, fuel, exhaust and cooling system, as well as safety related equipment such as parking lights, headlamps and taillights) in low speed collisions.

Bumpers were originally made from damage resistant materials such as heavy steel. However, more recent advances in motor vehicle design have made modern vehicle bumpers much more susceptible to damage. Motor vehicles today are typically designed so that during a collision parts of the vehicle crumple in predetermined patterns to absorb the energy from the impact and maintain the integrity of the passenger compartment. In other words, bumpers and other components are designed to crumple in a collision in order to protect the passengers. Further, many vehicle bodies are now composed of lightweight materials, e.g., aluminum composites, to improve fuel efficiency and to enhance the handling and performance of the vehicles. An unfortunate drawback of such developments, however, is that even though modern vehicles are safer, they are also considerably more fragile. Today, even light or low-impact collisions may cause significant damage and require expensive repairs.

In contrast to bumpers used on earlier vehicles, bumpers on modern cars and trucks are relatively lightweight and are largely non-metallic. Many consist of only an inner core of an expanded polystyrene thermoplastic foam material and a thin rubber and/or plastic outer shell layer. Modern bumpers are also much more likely to be integrated into the overall body design of a motor vehicle and are typically painted to match the vehicle body. As a result, bumpers are more difficult to repair or replace and damage to the bumper is much more conspicuous and noticeable than it was for earlier designs.

A number of different after-market bumpers and bumper protection systems have been developed in order to provide further protection to the bumpers of modern motor vehicles, including for example brush guards, push bars, and bumper covers and pads. These designs, however, typically suffer from a number of shortcomings such as expense, difficulty of installation, or susceptibility to damage from corrosive environments. These shortcomings are especially apparent for high-risk vehicles such as work trucks, delivery trucks, and utility vehicles which frequently collide with structures such as loading docks, bollards, or other vehicles.

What is needed is an improved vehicle bumper that is relatively inexpensive, easy to install and replace and that significantly eliminates or reduces bumper or vehicle damage from low impact collisions.

### SUMMARY OF THE INVENTION

An object of the invention, therefore, is to provide a novel bumper system that is relatively inexpensive, easy to install and replace and that significantly eliminates or reduces bumper or vehicle damage from low impact collisions.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows a bumper according to the present invention mounted onto the rear of a commercial-type truck.

FIG. 2A shows a view of the rear bumper of FIG. 1 from the backside and bottom of the bumper.

FIG. 2B shows a view of the rear bumper of FIG. 1 from the side of the bumper facing away from the vehicle.

FIGS. 3A and 3B show a preferred mounting system for a bumper according to the present invention.

FIGS. 4A, 4B, and 4C show a preferred bumper pad according to the present invention from the bottom, mounting side, and top.

FIGS. 5A and 5B show a preferred bumper pad according to the present invention from the front and rear.

FIG. 6 shows a logo label plug that can be inserted into a bumper pad according to the present invention.

FIG. 7 shows a preferred embodiment of the present invention comprising a left bumper pad, a middle bumper pad, and a right bumper pad.

FIG. 8 shows an end view of a left bumper pad and a right bumper pad according to the present invention.

FIG. 9 shows a cross section of a preferred embodiment of the present invention comprising a left bumper pad, a middle bumper pad, and a right bumper pad.

FIGS. 10A, 10B, and 10C show bumpers according to the present invention where the number of middle bumper pad sections are varied to make the bumper longer or shorter.

FIG. 11A shows the maximum deformation of a bumper pad according to the present invention during a collision with a flat barrier at around 3 mph.

FIG. 11B shows the maximum deformation of a bumper pad according to the present invention during a collision with a flat barrier at around 5 mph.

FIG. 11C shows the maximum deformation of a bumper pad according to the present invention during a pole collision at around 2 mph.

### DETAILED DESCRIPTION OF PREFERRED EMBODIMENTS

Preferred embodiments of the present invention provide a novel bumper system that is relatively inexpensive, easy to install and replace, and that significantly eliminates or reduces bumper or vehicle damage from low impact collisions. The present invention is particularly suited for bumper systems used on work trucks, delivery vehicles, utility vehicles, or fleet vehicles, although the invention is not limited to those applications. In a preferred embodiment, the use of multiple bumper pads, each having multiple crush cells and formed from a suitably elastic material, serves to significantly reduce or eliminate damage to the vehicle resulting from a collision. Damages to the colliding vehicle(s) and/or the object(s) collided with are also eliminated or reduced.

Preferred embodiments of the present invention provide for simple and rapid replacement of damaged pads, without having to replace undamaged parts of the bumper. Costly vehicle down time resulting from collision damage is also reduced.

A preferred method or apparatus of the present invention has many novel aspects, and because the invention can be embodied in different methods or apparatuses for different purposes, not every aspect need be present in every embodiment. Moreover, many of the aspects of the described embodiments may be separately patentable.

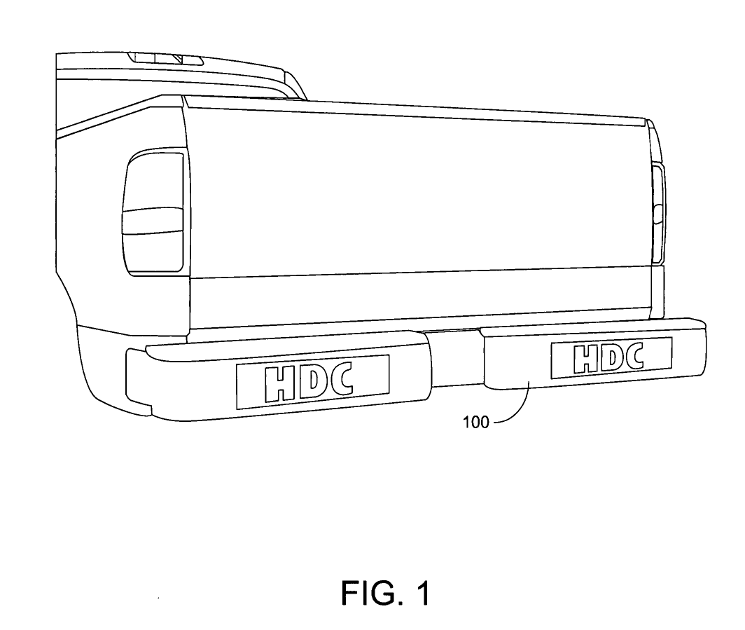

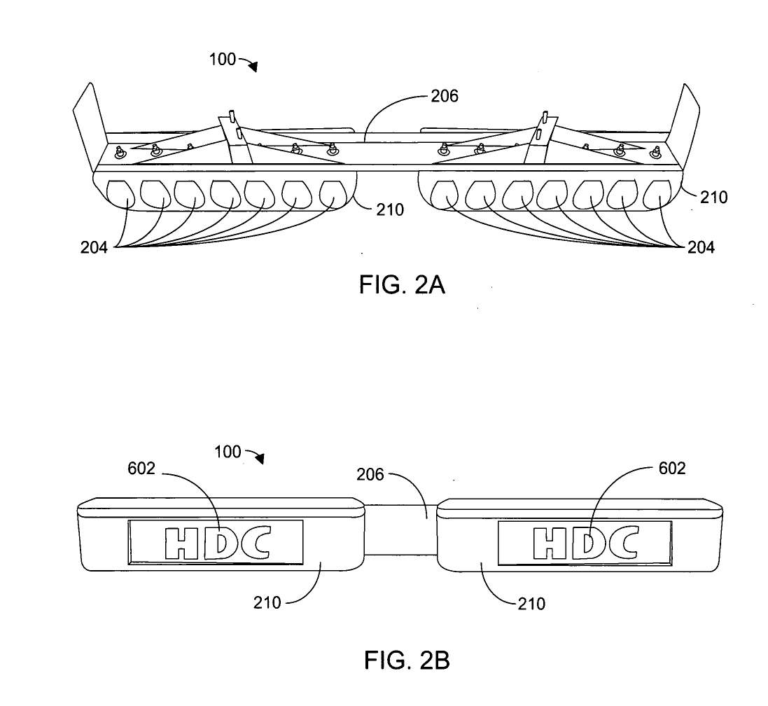

In one preferred embodiment of the present invention, a modular elastic bumper with multiple crush cells is used to protect a motor vehicle from damage resulting from low-impact collisions. FIG. 1 shows an example of a bumper 100 according to the present invention mounted onto the rear of a commercial-type truck. FIG. 2A shows a view of the rear bumper of FIG. 1B from the backside (the side that would be toward the vehicle body when the bumper is mounted, also referred to as the proximal surface) and bottom of the bumper. FIG. 2B shows a view of the rear bumper of FIG. 1B from the front of the bumper (the side that would be away from the vehicle body when the bumper is mounted, also referred to as the distal surface).

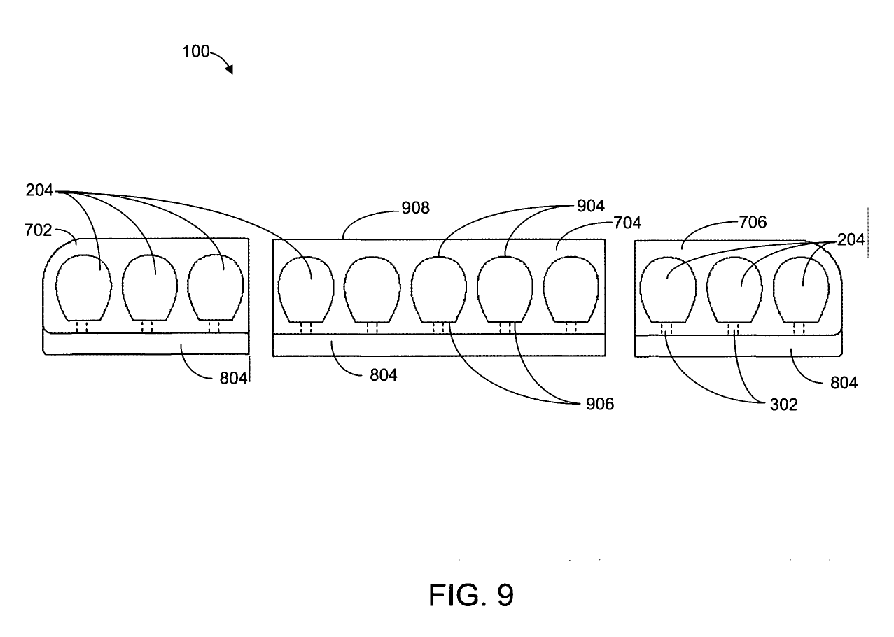

Bumper 100 preferably comprises two or more bumper pads 210, each pad composed of an elastic material and containing multiple crush cells 204 within the body of the pad. The crush cells 204 collapse upon impact thus increasing the impact or energy absorption capability of the bumper pad 210. The crush cells also reduce the pad's weight and overall material cost. Referring also to FIG. 9, the crush cells 210 preferably have a generally horseshoe shaped horizontal cross-section, forming an arch with the crown toward the distal surface 908 of the bumper, rounded sides, and a flat proximal surface. The preferred shape can also generally be described as a truncated ellipse or oval, with the flattened or truncated end toward (proximal to) the vehicle when the bumper is mounted. Although other shapes could be employed, the truncated ellipse or oval shape is preferred because it allows the crush cells to be strong enough to resist an impact so that much of the energy of a collision is used to collapse the cells; while the flat proximal surface facilitates mounting the bumper onto a mounting sub-frame as discussed below.

The upper surface of each pad is preferably textured to allow it to be used as a non-slip step. Bumper pads are preferably composed of an elastic material such as Ethylene Propylene Diene Monomer (EPDM) which allows large elastic deformations. A preferred elastic material will also be rust and corrosion proof, resist oil, gas, acid, and other corrosive materials, and stand up well to extreme environmental conditions.

Table 1 shows a number of suitable elastic materials and assigns each relative scores based on material cost and resistance to certain corrosive materials and environmental conditions.

TABLE 1

| | | Butyl Rubber | | Butyl | | | Polypropylene | | ECCOSIL | ECCOSIL | SILASTIC |
|---|---|---|---|---|---|---|---|---|---|---|---|
| | EPDM | 50% HAF black | EPM | Rubber | CPE | Polyisoprene | oxide | CSM | 4122 | 4954 | 590 |
| Material Cost | | | | | | | | | | | |
| Cost | 0 | 0 | 0 | 0 | −2 | 0 | −3 | −2 | −14 | −30 | −19 |
| Environmental | | | | | | | | | | | |
| Resistance | | | | | | | | | | | |
| Flammability | 0 | 0 | 0 | 0 | 0 | 0 | 0 | 0 | 3 | 3 | 3 |
| Fresh Water | 0 | 0 | 0 | 0 | 0 | 0 | 0 | −1 | 0 | 0 | 0 |
| Organic Solvents | 0 | 0 | 0 | 0 | 0 | 0 | 0 | 0 | 1 | 1 | 1 |
| Oxidation | 0 | 0 | 0 | −1 | 0 | −1 | 0 | −1 | −1 | −1 | −1 |
| Sea Water | 0 | 0 | 0 | 0 | 0 | 0 | 0 | −1 | 0 | 0 | 0 |
| Strong Acid | 0 | 0 | 0 | 0 | 1 | 0 | 0 | 0 | 2 | 2 | 2 |
| Strong Alkalis | 0 | 0 | 0 | 0 | 0 | −2 | −2 | −1 | 0 | 0 | 0 |
| Weak Acid | 0 | 0 | −1 | 0 | −1 | 0 | 0 | −1 | 0 | 0 | 0 |
| Weak Alkalis | 0 | 0 | 0 | 0 | 0 | −1 | −1 | −1 | 0 | 0 | 0 |
| UV | 0 | 0 | 0 | 0 | 0 | 0 | 0 | 0 | 0 | 0 | 0 |
| Wear | 0 | 0 | 0 | 0 | 0 | 0 | 0 | 0 | −1 | −1 | −1 |
| Total | 0 | 0 | −1 | −1 | 0 | −4 | −3 | −6 | 4 | 4 | 4 |
| Grand Total | 0 | 0 | −1 | −1 | −2 | −4 | −6 | −8 | −10 | −26 | −15 |

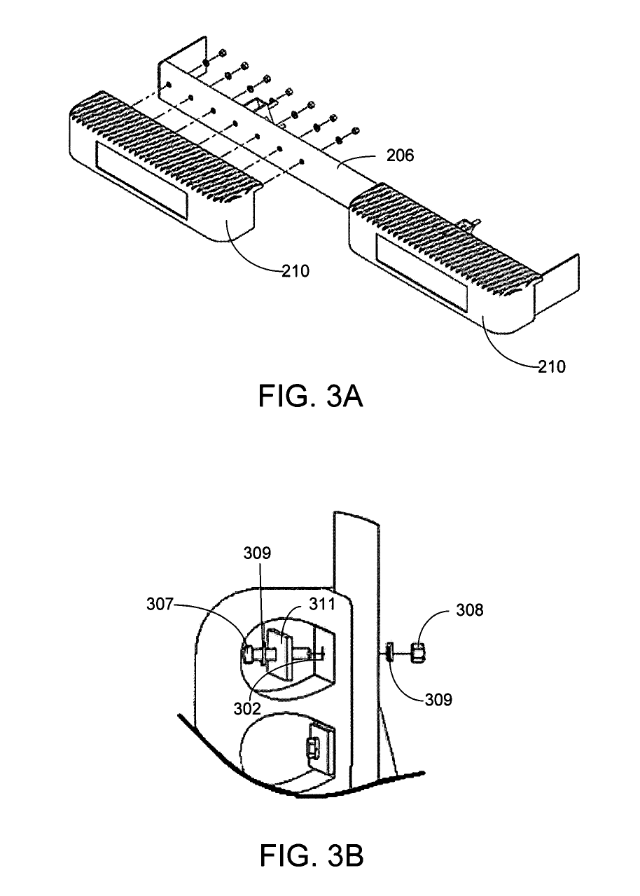

Bumper pads 210 can be mounted to a vehicle using, for example, a mounting sub-frame 206 or any other suitable means. Referring also to FIG. 9, mounting can be accomplished by using bolts or similar fasteners extending through bolt mounting slots 302 formed through the back wall 906 of the crush cells 204 through the pad material and exiting on the rear mounting surface (proximal to the vehicle). In the preferred embodiment shown in FIGS. 3A and 3B, bolt 307, locking nut 368, washer 309, and bumper pad 210 are used to attach bumper pad 210 to sub-frame 206 through the back wall 906 of each crush cell 204 (although in some embodiments such attachment will not take place in each crush cell). As shown in FIG. 3B, bolt 307 passes through mounting slot 302 between each crush cell 204 and the rear or proximal mounting surface. Preferably, crush cells 204 are open at the bottom of bumper pad (as shown in FIG. 2A) for easy access so that bumper pad 210 can be easily installed or removed.

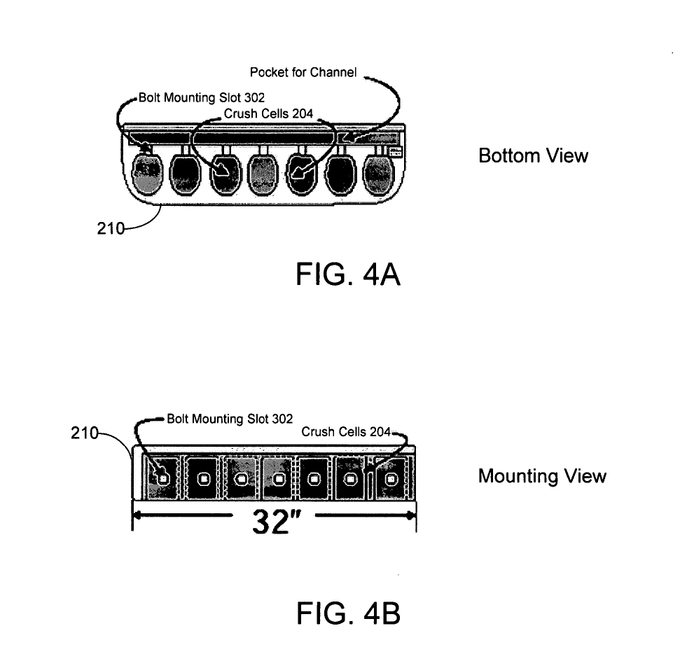

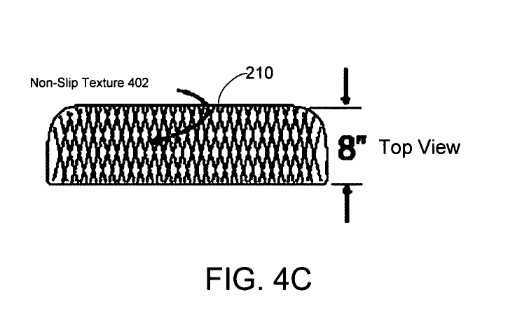

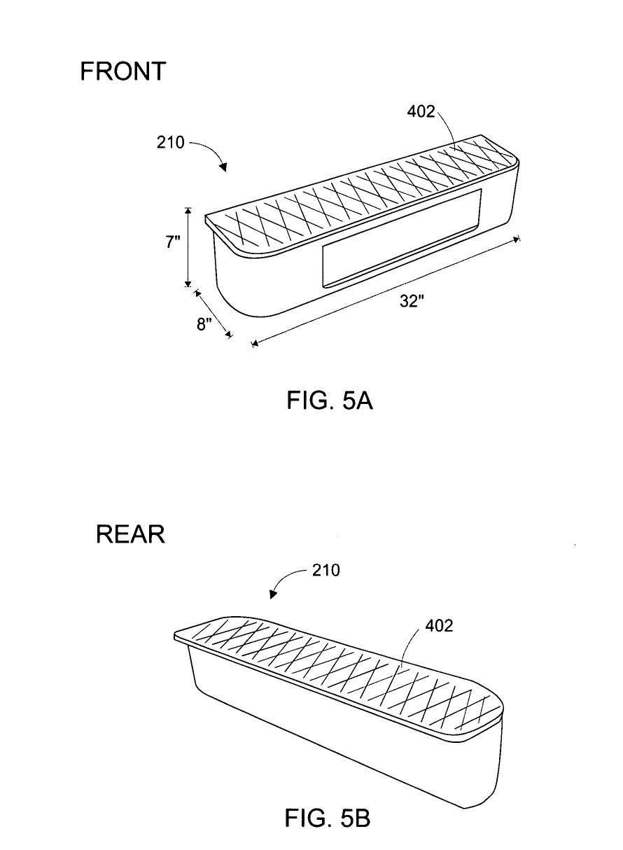

FIGS. 4A through 4C show a preferred bumper pad 210 from the bottom, mounting side and top. FIG. 5 shows a preferred bumper pad 210 from the front and rear. As shown in FIGS. 4B and 4C and FIG. 5, the illustrated bumper is 32″ long, 7″ tall, and 8″ wide, although other dimensions could be used. Skilled persons will recognize that for the bumper to be safely used as a step it is desirable that the bumper pad have a tread greater than 7″ deep. A thinner tread could be used but there would be a greater risk of someone's foot slipping from the tread. A non-slip texture is preferably formed into the bumper pad material on the upper surface 402. Alternatively, a separate texture or textured surface could be affixed to the upper surface.

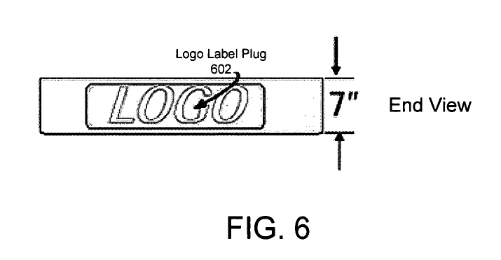

FIG. 6 shows an example of a logo label plug 602 that can be inserted into the front or distal surface (away from the vehicle) of the bumper pad. Two logo label plugs 602 with the logo “HDC” are shown inserted into the bumper pads in FIG. 2B. Preferably, the logo label plugs are formed from the same material as the bumper pad and affixed by using a suitable adhesive. Alternatively, a logo could be formed into the bumper pad material on the distal surface. A company or business could thus use this type of private labeling to display the company name on the bumpers to signify ownership or to advertise the company name. By forming the logo in the same material as the bumper pads, the logo will be longer lasting and less easily damaged than a typical logo painted onto a vehicle or on a sticker or similar device attached to the vehicle.

In a preferred embodiment, the bumper pads 210 are independent modules, meaning that any one pad can be replaced without affecting or replacing the other pads. In the event that a bumper pad is damaged, this serves to make repairs easier and cheaper since undamaged parts of the bumper don't have to be replaced. In one preferred embodiment of the present invention, all pads are identical so that any pad can be replaced with any other pad.

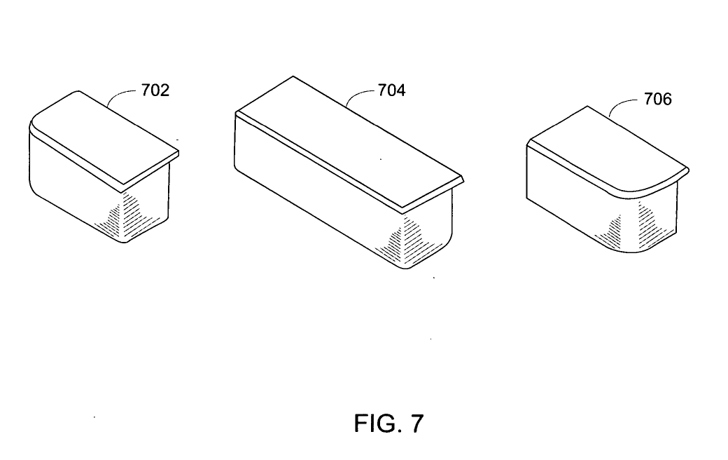

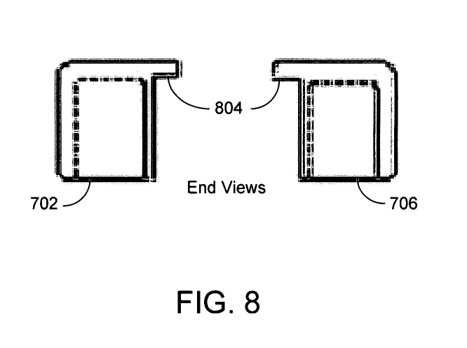

Alternatively, dedicated right and left pads could be used so that each pad must be replaced with a corresponding pad. FIG. 7 shows a preferred embodiment of the present invention comprising a left bumper pad 702, a middle bumper pad 704, and a right bumper pad 706. FIG. 8 shows an end view of a left bumper pad 702 and a right bumper pad 706 according to the present invention. Lip 804 can be formed on the upper proximal surface of the bumper pads to cover the mounting joint when the pads are attached to the vehicle.

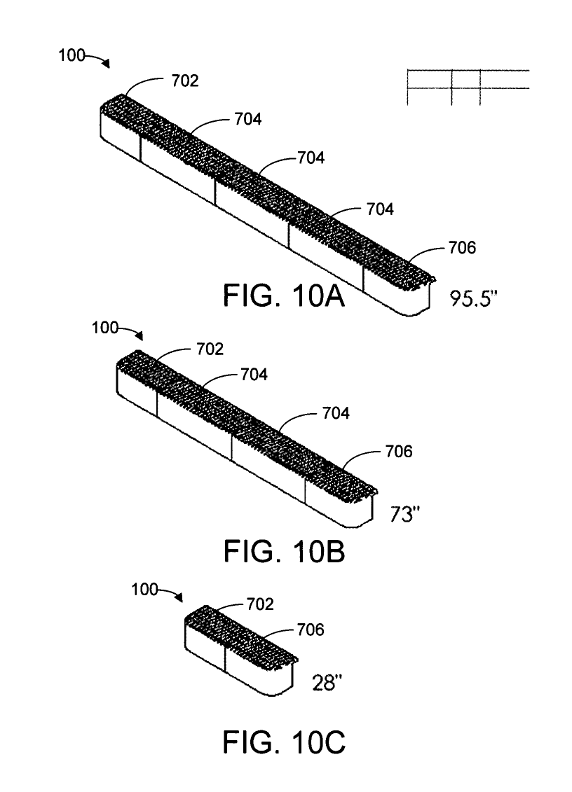

FIG. 9 shows a cross-section view of a preferred embodiment of the present invention comprising a left bumper pad 702, a middle bumper pad 704, and a right bumper pad 706. In contrast to the divided bumper pads shown for example in FIG. 2B, the bumper pads shown in FIG. 7 and FIG. 9 can be used to form a continuous bumper. While this arrangement is not as flexible when it comes to pad replacement, it allows multiple center pads to be used to accommodate any size bumper on any size vehicle. For example, as shown in FIGS. 10A through 10C, the number of middle sections use can be varied to make the bumper section longer or shorter. In the embodiment shown in FIG. 10A, three identical center sections 704 have been used along with right pad 706 and left pad 702 to form a continuous bumper 100 that is 95.5″ in length. In the embodiment shown in FIG. 10B, only two center sections 704 have been used with right and left pads (706 and 702) to form a continuous bumper 100 that is 73″ in length. In the embodiment shown in FIG. 10C, only the right and left pads (706 and 702) have been used to form a bumper 100 that is 28″ in length.

In some embodiments of the present invention, one or more of the bumper pads can be mounted vertically, rather than horizontally, in order to provide additional protection. For example, bumper pads could be mounted vertically on the corners of a vehicle or at the bow of a boat. Pads can also be combined in any desired pattern to protect stationary objects such as loading docks. The number of pads to be used and the arrangement of mounted pads depends on the size and shape of the vehicle or object to be protected.

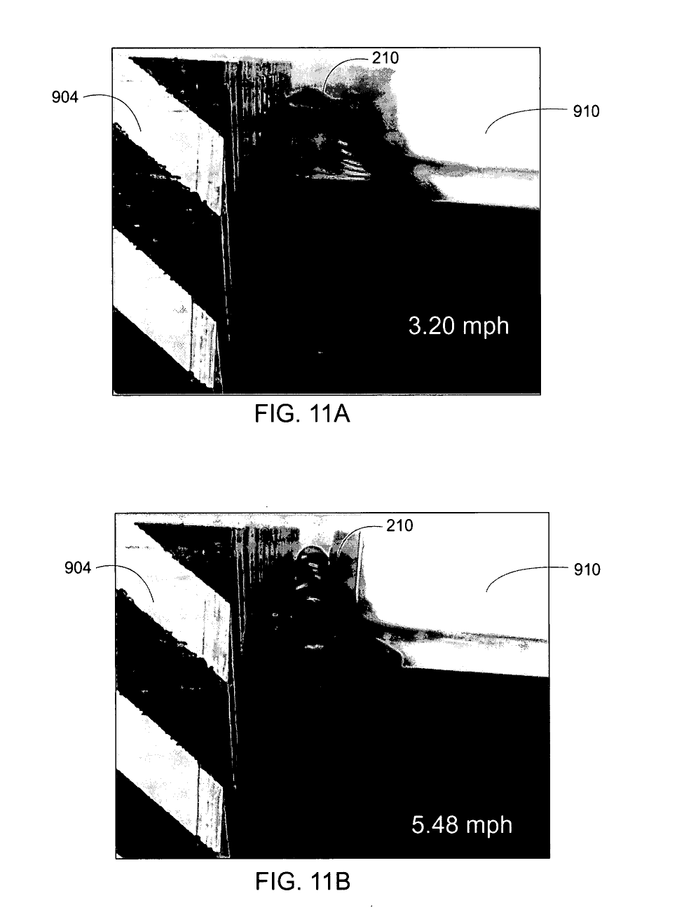

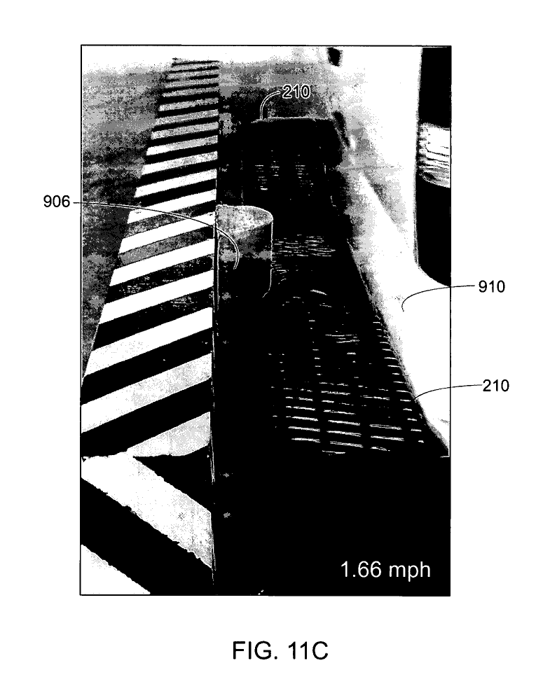

A bumper according to the present invention has been shown to substantially reduce impact acceleration and decrease the force transmitted to the vehicle as a result of the collision. The elastic material preferably used in the construction of Applicant's bumper absorbs impacts and reduces impact acceleration. As shown in FIG. 11A, Applicant's bumper pad 210 mounted onto motor vehicle 910 (a 2006 FORD F-150 truck in this example) shows some deformation on a collision with a flat barrier 904 at around 3 mph. As shown in FIG. 11B, more deformation is seen at around 5 mph. However, the combination of an 8″ bumper with numerous crash cells and a suitably elastic material serves to eliminate bumper or vehicle damage at these low-impact speeds. The same is true for pole 906 collision at around 2 mph as shown in FIG. 11C.

Tests conducted by Applicant show that a modular elastic bumper with multiple crush cells according to the present invention can decrease the force applied to a vehicle, operator(s), and cargo during a low-speed collision by over 25%. At low-impact speeds (<6 mph) a bumper according to the present invention can also increase impact duration by 26%. This decreases the abruptness (jerk) of impact by over 71%. These percentages reduce injuries and their costs to involved parties or fragile cargo. At low-impact speeds, a vehicle equipped with a bumper according to the present invention will likely encounter no damage to bumper or vehicle due to the elasticity of the bumper, while a stock bumper will experience damage. Further, a bumper according to the present invention has structural capabilities that reach far beyond an average stock bumper. It takes a large amount of force to significantly displace the bumper of the present invention (over 60,000N resulted in a displacement of less than 0.07 m) and even greater force to weaken its structure.

With a stock metal bumper, the test vehicle showed permanent deformation to the bumper and damage to vehicle in a collision of 1.62 mph. A bumper according to the present invention, however, withstood a 5.48 mph flat barrier impact with negligible (or no) damage to bumper or vehicle and withstood. Further, Applicant's bumper suffered no damage in a pole barrier tests at 1-2 mph. It is likely that repeated impacts will weaken the crush cells and diminish the bumper's effectiveness, however, even then the bumper should remain fully functional and outperform the typical stock bumper.

Computer simulations also show that a bumper according to the present invention would be effective at preventing or reducing damage even for vehicles as large as 8000 kg.

Preferred embodiments of the present invention can be applied to virtually any type of motor vehicle, including for example trucks, ambulances, service vehicles, tow vehicles, or trailers. A bumper according to the present invention (mounted on either the front or rear of a vehicle) can even be used as a push bumper by emergency or other vehicles to move a stalled vehicle off the road. A rear ambulance bumper according to the present invention would not only give emergency crews a sure and non-slip footing to step in and out of the vehicle, the bumper would also prevent damage to the gurney when, as is typical, emergency crew members intentionally roll the gurney into the rear bumper in order to collapse the front legs and slide the gurney into the ambulance. Preferred embodiments of the present invention can also be used with boats, construction equipment, or airport luggage carts or even for stationary objects such as loading docks or marine docks.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A bumper device for mounting onto a vehicle, the bumper device comprising:
one or more bumper pads formed from an elastic material, said pads having a mounting surface proximal to said vehicle;
two or more hollow cells within each bumper pad; and
at least one opening formed between each hollow cell and the proximal surface.

2. The bumper device of claim 1 in which the elastic material is rubber or ethylene propylene diene monomer.

3. The bumper device of claim 1 in which each bumper pad is a one piece molded bumper pad.

4. The bumper device of claim 1 in which the bumper pads are independent modules such that one can be replaced without affecting another bumper pad.

5. The bumper device of claim 1 in which the two or more hollow cells have a distal interior surface opposite the proximal mounting surface, and in which said interior distal surface is shaped to form an arch with the crown of the arch directed away from the proximal mounting surface.

6. The bumper device of claim 1 in which the two or more hollow cells form a flat surface on the proximal interior surface of the cells.

7. A bumper pad for absorbing impact energy, the pad comprising a one-piece molded pad formed from an elastic material and having two or more hollow cells within the pad.

8. The bumper pad of claim 7 further comprising an upper surface textured to minimize slipping when said pad is used as a step.

9. The bumper pad of claim 7 further comprising a mounting surface for mounting the bumper pad and wherein the interior surface of the two or more hollow cells forms an arch with the crown of the arch distal to the mounting surface.

10. The bumper pad of claim 7 in which the elastic material is rubber or ethylene propylene diene monomer.

11. A bumper device for mounting onto the front or back of a vehicle, the bumper device comprising:
a first bumper pad for mounting on the right of the vehicle, said pad having a right end, a left end, and proximal surface for mounting onto the vehicle, and a distal side opposite the vehicle, said left end adapted to butt against another bumper pad when mounted;
a second bumper pad for mounting on the left of the vehicle, said pad having a right end, a left end, and proximal surface for mounting onto the vehicle, said right end adapted to butt against another bumper pad when mounted; and
wherein each bumper pad is formed from an elastic material and has two or more hollow cells within each bumper pad.

12. The bumper device of claim 11 wherein the two or more hollow cells have a cross section in the shape of a truncated oval, with the truncated end proximal to the vehicle when the bumper is mounted.

13. The bumper device of claim 11 wherein the two or more hollow cells have a cross section in the shape of a truncated ellipse, with the truncated end proximal to the vehicle when the bumper is mounted.

14. The bumper device of claim 11 further comprising one or more additional bumper pads having a right end and a left end, wherein both ends are adapted to butt against another bumper pad when mounted.

15. The bumper device of claim 11 wherein said distal side is adapted so that a label plug having a design or logo can be inserted into said bumper pad.

16. The bumper device of claim 11 in which the elastic material is rubber or ethylene propylene diene monomer.
